(19) United States
(12) Patent Application Publication
(10) Pub. No.: US 2017/0185685 A1
(43) Pub. Date: Jun. 29, 2017

(54) SYSTEMS AND METHODS FOR RECOMMENDING PAGES

(71) Applicant: Facebook, Inc., Menlo Park, CA (US)

(72) Inventors: Jason Brewer, Kirkland, WA (US); Bradley Ray Green, Snohomish, WA (US); Jinyi Yao, Issaquah, WA (US); Komal Kapoor, Bellevue, WA (US)

(21) Appl. No.: 14/980,669

(22) Filed: Dec. 28, 2015

(51) Int. Cl. G06F 17/30

(52) U.S. Cl. CPC G06F 17/30867; G06F 17/3087

(57) ABSTRACT

Systems, methods, and non-transitory computer-readable media can determine respective geographic locations of a set of users associated with a page that is accessible through a social network. At least one centroid for the page can be generated based at least in part on the respective geographic locations of the set of users. At least one area of influence of the page can be determined based at least in part on the centroid. At least one page recommendation can be presented to one or more users in the set of users based at least in part on the area of influence of the

### FIELD OF THE INVENTION

The present technology relates to the field of content provision. More particularly, the present technology relates to techniques for recommending pages.

### BACKGROUND

Today, people often utilize computing devices (or systems) for a wide variety of purposes. Users can use their computing devices to, for example, interact with one another, access content, share content, and create content. In some cases, content items can include postings from members of a social network. The postings may include text and media content items, such as images, videos, and audio. The postings may be published to the social network for consumption by others.

Under conventional approaches, a user may navigate to or be presented with various content items in a social network. The content items can come from pages associated with members of the social network. In some instances, the content items may be of high interest to the user. If the user expresses interest in a particular content item, the social network may attempt, based on the content item, to provide to the user additional content items that would also be of interest to the user. Providing such additional content items can enhance the user experience and may help realize the full potential of the social network. Unfortunately, attempts to provide such additional content items and to maintain a high level of interest from the user often fail. The growing size of social networks can also pose problems with respect to the goal of providing content items of high interest to the user. As available content grows in amount, in theory, the likelihood of finding more content items of high interest to the user should increase. However, in practice, the ability to identify content items of high interest to the user can be complicated by the sheer volume of content.

### SUMMARY

Various embodiments of the present disclosure can include systems, methods, and non-transitory computer readable media configured to determine respective geographic locations of a set of users associated with a page that is accessible through a social network. At least one centroid for the page can be generated based at least in part on the respective geographic locations of the set of users. At least one area of influence of the page can be determined based at least in part on the centroid. At least one page recommendation can be presented to one or more users in the set of users based at least in part on the area of influence of the page.

In an embodiment, the systems, methods, and non-transitory computer readable media are configured to determine the geographic location of a user based on an address referenced in a social network profile of the user, determine the geographic location of the user based on a centroid of geographic locations that correspond to check-ins performed by the user through the social network, or determine the geographic location of the user based on a centroid of geographic locations that correspond to social connections of the user in the social network.

In an embodiment, the systems, methods, and non-transitory computer readable media are configured to determine a mean of the respective latitude-longitude coordinates corresponding to each user in the set of users and determine the centroid for the page based on the mean.

In an embodiment, the systems, methods, and non-transitory computer readable media are configured to determine that a number of the users associated with the page satisfy a large page threshold, determine a sample of the set of users, determine a mean of the respective latitude-longitude coordinates corresponding to each user in the sample, and determine the centroid for the page based on the mean.

In an embodiment, the systems, methods, and non-transitory computer readable media are configured to determine that a number of the users associated with the page satisfy a small page threshold, generate a preliminary centroid for the page using a first sample of the set of users, determine a second sample of users by discarding at least one user from the first sample having a geographic distance from the preliminary centroid that satisfies a threshold number of standard deviations, and generate the centroid for the page using the second sample of the set of users.

In an embodiment, the systems, methods, and non-transitory computer readable media are configured to determine that the set of users associated with the page has a multi-modal distribution, cluster the set of users into at least a first cluster and a second cluster, generate at least a first centroid based at least in part on the first cluster of users, and generate at least a second centroid based at least in part on the second cluster of users.

In an embodiment, the systems, methods, and non-transitory computer readable media are configured to determine one or more areas of influence in which a respective threshold percentage of users associated with the page are geographically located.

In an embodiment, the systems, methods, and non-transitory computer readable media are configured to determine a threshold similarity between an area of influence of at least one candidate page and the area of influence of the page.

In an embodiment, the systems, methods, and non-transitory computer readable media are configured to determine a threshold similarity between an area of influence of at least one candidate page and the area of influence of the page and determine that a geographic reach category for the candidate page matches a geographic reach category for the page.

In an embodiment, the geographic reach category categorizes a page as having a local, regional, or country-wide area of influence.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example page module, according to an embodiment of the present disclosure.

FIG. 2 illustrates an example of a page centroid module configured to determine one or more centroids for pages, according to an embodiment of the present disclosure.

FIG. 3 illustrates an example of a page recommendation module configured to provide page recommendations, according to an embodiment of the present disclosure.

FIG. 4 illustrates an example process for determining page recommendations, according to an embodiment of the present disclosure.

FIG. 5 illustrates an example process for generating multiple centroids for a page, according to various embodiments of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Recommending Pages

Today, people often utilize computing devices (or systems) for a wide variety of purposes. Users can use their computing devices to, for example, interact with one another, access content, share content, and create content. In some cases, content items can include postings from members of a social network. The postings may include text and media content items, such as images, videos, and audio. The postings may be published to the social network for consumption by others.

Under conventional approaches, a user may navigate to or be presented with various content items in a social network. The content items can come from pages associated with members of the social network. In some instances, the content items may be of high interest to the user. If the user expresses interest in a particular content item, the social network may attempt, based on the content item, to provide to the user additional content items that would also be of interest to the user. Providing such additional content items can enhance the user experience and may help realize the full potential of the social network. Unfortunately, attempts to provide such additional content items and to maintain a high level of interest from the user often fail. The growing size of social networks can also pose problems with respect to the goal of providing content items of high interest to the user. As available content grows in amount, in theory, the likelihood of finding more content items of high interest to the user should increase. However, in practice, the ability to identify content items of high interest to the user can be complicated by the sheer volume of content. Accordingly, such conventional approaches may not be effective in addressing these and other problems arising in computer technology.

An improved approach rooted in computer technology overcomes the foregoing and other disadvantages associated with conventional approaches specifically arising in the realm of computer technology. In various embodiments, a social networking system may provide pages that are accessible to users of the social networking system. A page may correspond to an entity (e.g., a business, topic, location, user, etc.). Users of the social networking system can navigate to the page to learn more about the entity as well as access and/or post content through the page. Such content may include text and/or media content items, such as images, videos, and audio. Users of the social networking system have the option to be associated with the page, for example, by “liking” the page (e.g., selecting a “like” option through the social networking system) or by becoming a “fan” the page (e.g., selecting a “fanning” option through the social networking system). In some instances, the social networking system can include content items that are posted to the page in the respective news feeds of users that are associated with the page. One or more administrators may be associated with the page and these administrators may carry privileges that permit them to perform various tasks with respect to the page. In some instances, an administrator of the page can assign a geographic location to the page. However, an assigned geographic location may not accurately represent a geographic region that corresponds to the users that are associated with the page. For instance, a page for a coffee company may be assigned San Francisco, Calif. as its geographic location. However, users that have fanned the page may be spread throughout the United States. In various embodiments, one or more geographic locations, or centroids, can be determined for a page that best represent the geographic locations of users associated with the page. The respective locations of the users associated with the page can be evaluated to determine one or more centroids for the page and to define the distribution of the locations of connections to the page. Based on the variance of the distribution of user locations, the page may be classified in a local, regional, country, or global page category. For example, the centroid(s) determined for the page can be used to determine one or more radii that represent areas of influence for the page. For example, a geographic region corresponding to a p25 radius that extends from a centroid of the page includes 25 percent of the users that are associated with the page. In another example, a geographic region corresponding to a p50 radius that extends from a centroid of the page includes 50 percent of the users that are associated with the page. Further, a geographic region corresponding to a p75 radius that extends from a centroid of the page includes 75 percent of the users that are associated with the page. In various embodiments, the centroids and/or respective areas of influence for pages can be utilized to provide page recommendations, filtering, and/or targeting, for example.

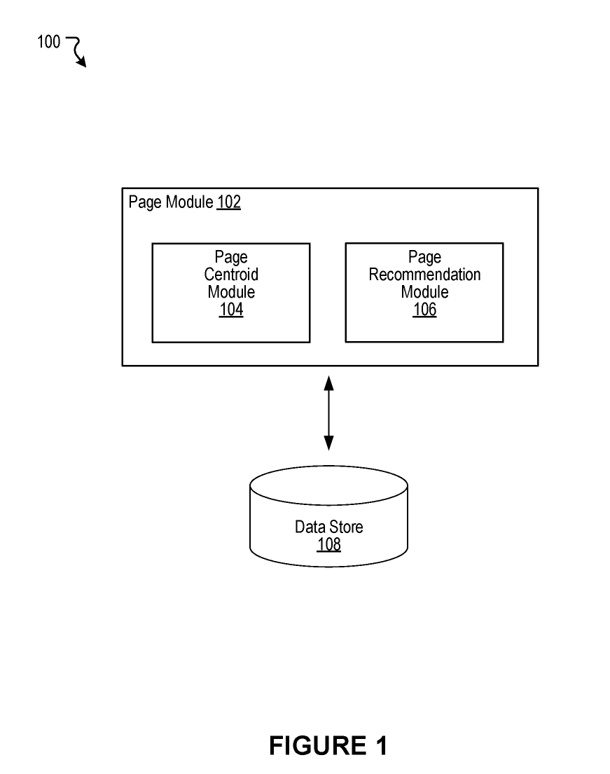

FIG. 1 illustrates an example system 100 including an example page module 102, according to an embodiment of the present disclosure. As shown in the example of FIG. 1, the page module 102 can include a page centroid module 104 and a page recommendation module 106. In some instances, the example system 100 can include at least one data store 108. The components (e.g., modules, elements, etc.) shown in this figure and all figures herein are exemplary only, and other implementations may include additional, fewer, integrated, or different components. Some components may not be shown so as not to obscure relevant details.

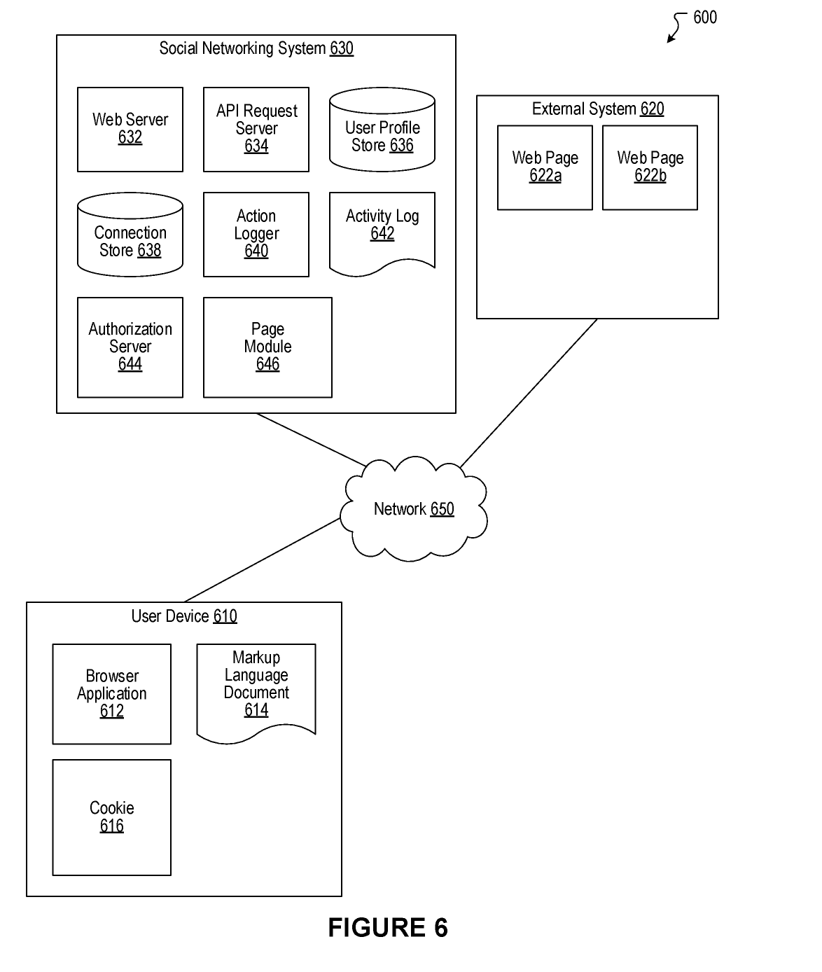

In some embodiments, the page module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the page module 102 can be implemented, in part or in whole, as software running on one or more computing devices or systems, such as on a user or client computing device. In one example, the page module 102 or at least a portion thereof can be implemented as or within an application (e.g., app), a program, or an applet, etc., running on a user computing device or a client computing system, such as the user device 610 of FIG. 6. In another example, the page module 102 or at least a portion thereof can be implemented using one or more computing devices or systems that include one or more servers, such as network servers or cloud servers. In some instances, the page module 102 can, in part or in whole, be implemented within or configured to operate in conjunction with a social networking system (or service), such as the social networking system 630 of FIG. 6.

The page module 102 can be configured to communicate and/or operate with the at least one data store 108, as shown in the example system 100. The at least one data store 108 can be configured to store and maintain various types of data including audience data that identifies users of the social networking system that have “liked” or “fanned” pages that are available for access through the social networking system. The audience data can also describe respective geographic locations that have been determined to correspond to the various users of the social networking system. The data store 108 can also store data that identifies respective centroids and/or areas of influence for various pages that are available for access through the social networking system. In some implementations, the at least one data store 108 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 108 can store information associated with users, such as user identifiers, user information, profile information, user specified settings, content produced or posted by users, and various other types of user data.

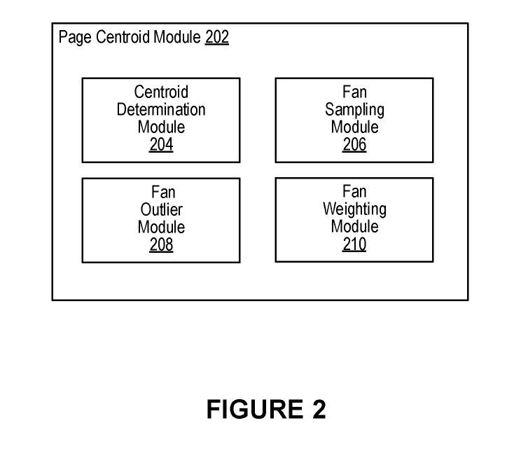

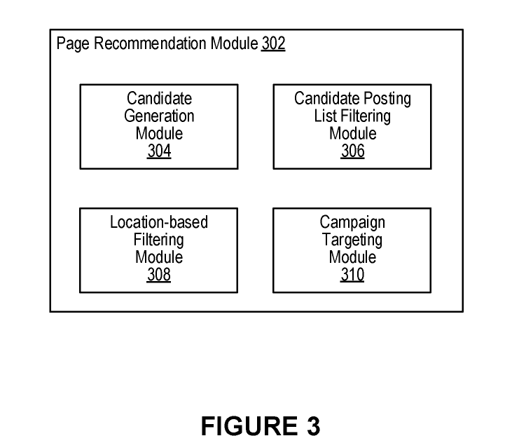

In various embodiments, the page centroid module 104 can be configured to generate one or more centroids for a page based on the respective geographic locations determined for users that are associated with the page. Based on the centroid(s) determined for the page, the page centroid module 104 can determine one or more radii that correspond to the page's varying areas of influence (e.g., a p25 radius, a p50 radius, and/or a p75 radius). More details regarding the page centroid module 104 will be provided below with reference to FIG. 2. The page recommendation module 106 can be configured to utilize the centroids and/or respective areas of influence for various pages, for example, to provide content (e.g., pages) recommendations, filtering, targeting, etc. More details regarding the page recommendation module 106 will be provided below with reference to FIG. 3.

FIG. 2 illustrates an example of a page centroid module 202 configured to determine one or more centroids for pages, according to an embodiment of the present disclosure. In some embodiments, the page centroid module 104 of FIG. 1 can be implemented as the page centroid module 202. As shown in FIG. 2, the page centroid module 202 can include a centroid determination module 204, a fan sampling module 206, a fan outlier module 208, and a fan weighting module 210.

The centroid determination module 204 can be configured to determine one or more respective centroids for pages. When determining a centroid for a page, the centroid determination module 204 can determine a set of geographic locations for each user (i.e., “fan”) associated with the page. In some embodiments, the geographic location of a user may be determined using a geographic location (e.g., home address, city, zip code, etc.) that is provided by the user. In some embodiments, the geographic location of the user may be determined based on the user's check-ins at points of interest (e.g., places such as restaurants, stores, malls, movie theatres, etc.) over a period of time. For instance, a user can check-in to a point of interest through a software application (e.g., social networking application) running on the user's mobile device. Upon checking in, the software application and/or the mobile device can determine the geographic location and/or the point of interest at which the check-in was performed. In such embodiments, a centroid location may be determined using the geographic locations of the points of interests at which the user checked-in and this centroid location can be used as the geographic location of the user. In some embodiments, the geographic location of the user may be determined based on the respective geographic locations that correspond to the user's social connections (e.g., “friends”) as recognized by the social networking system. In such embodiments, a centroid location may be determined using the geographic locations of the user's social connections and this centroid location can be used as the geographic location of the user. In various embodiments, each geographic location for a user can be represented as a set of latitude and longitude coordinates. The centroid determination module 204 can determine a centroid for the page by determining a mean of the latitude and longitude coordinates corresponding to the geographic locations of the users associated with the page. Based on the centroid, the centroid determination module 204 can determine one or more radii that correspond to the page's areas of influence. Each area of influence corresponds to a geographic region in which a certain number, or percentage, of the page's fans reside. In some embodiments, the centroid determination module 204 determines a p25 radius that extends from the centroid and corresponds to a geographic region in which 25 percent of the page's fans are located. In some embodiments, the centroid determination module 204 determines a p50 radius that extends from the centroid and corresponds to a geographic region in which 50 percent of the page's fans are located. In some embodiments, the centroid determination module 204 determines a p75 radius that extends from the centroid and corresponds to a geographic region in which 75 percent of the page's fans are located. In some embodiments, the centroid determination module 204 determines a p100 radius that extends from the centroid and corresponds to a geographic region in which 100 percent of the page's fans are located. These radii are provided merely as examples and such radii can be determined to correspond to geographic regions in which any specified number or percentage of the page's fans are located. In some embodiments, the respective areas of influence determined for a page can be used to categorize the page as having a local area of influence (e.g., including a city or a group of neighboring cities), a regional area of influence (e.g., including a state or a group of neighboring states), or a country area of influence (e.g., including a country or a group of neighboring countries). In various embodiments, the page centroid module 202 can be configured to re-generate centroids for pages at predefined intervals.

There may be instances where a page has more than one centroid. For example, a restaurant that has locations in both Los Angeles and in New York may have one set of fans that cluster around the Los Angeles area and one set of fans that cluster around the New York area. If the fan populations of these two areas were the same, then having just one centroid for the restaurant page would likely correspond to an inaccurate geographic location, such as somewhere in the Midwest United States. In some embodiments, more than one centroid can be determined for a page to prevent such inaccuracies. For example, the centroid determination module 204 can determine whether the restaurant page has a multi-modal distribution of fans. To determine whether the restaurant page has a multi-modal distribution, the centroid determination module 204 can cluster the geographic locations of the restaurant page's fans and compute a separate centroid for each cluster. Such clustering may be done using any generally known approach including, for example, graphical agglomerative clustering. At each iteration, the density of the respective p50 radius that extends from each centroid is measured. In some embodiments, if (i) the density of the clusters satisfies a threshold similarity across all of the clusters and (ii) each of the clusters have a threshold amount of separation from one another, then a determination is made that the restaurant page has a multi-modal distribution. As a result, the restaurant page is associated with the multiple centroids as well as the respective areas of influence (e.g., p25 radius, p50 radius, p75 radius, etc.) for each of the centroids.

Naturally, the number of fans associated with a page can vary. In some embodiments, the centroid determination module 204 can apply additional steps to improve centroid accuracy and the efficiency in which centroids are generated. For example, in some embodiments, the fan sampling module 206 can be utilized for pages that have a large number (e.g., 100,000 or more) of fans. In such embodiments, rather than determining centroids for the page using the geographic locations of every fan, the fan sampling module 206 can determine the centroids by sampling a portion of the page's fans. The fan sampling module 206 can select this sample uniformly at random. Further, the size of the sample can be chosen so that the centroid(s) determined for the page have a high confidence. In such embodiments, power can be calculated by assuming a mixture of Gaussian distributions.

The fan outlier module 208 can be utilized for pages that have a small number (e.g., less than 100,000) of fans. In some embodiments, a threshold number may be used for determining whether a page has a large number of fans or a small number of fans. For example, a page having a small number of fans can include outlier fans whose geographic locations may be vastly different from other fans of the page. For instance, a page may have 9 fans that are located in the Bay Area and one fan that is located in South Africa. In such instances, the centroid determined for the page is likely to not correspond to a realistic area of influence of the page and is therefore inaccurate. To address such outliers, the fan outlier module 208 can be configured to generate the centroid(s) for the page by first determining the centroid using a sample of the page's fans. Next, the fan outlier module 208 can compute the standard deviation of the respective geographic locations of the fans from the geographic location corresponding to the centroid. After comparing the respective distances of the fans to the centroid, the fan outlier module 208 can discard any outliers whose respective distance is more than n (e.g., 4) standard deviations from the centroid. After discarding the outliers, the fan outlier module 208 can re-generate the centroid using the geographic locations of the remaining, or non-discarded, fans of the page.

There may be instances where the geographic locations of certain types of fans are more indicative of a page's area of influence. For example, a page may have a number of fans and each fan may be categorized, for example, as an administrator of the page, an engaged fan of the page, or a new fan of the page. In this example, geographic locations of any administrators of the page can be more representative of the page's area of influence than fans of the page who are engaged (e.g., fans who actively access and/or post to the page). Similarly, the geographic locations of engaged fans may be more representative of the page's area of influence than new fans of the page. Thus, in some embodiments, when determining the centroid(s) for a page, the fan weighting module 210 can apply a value model of weights to the geographic location of each fan of the page. A different weight can be assigned depending on whether a fan is categorized as an administrator, an engaged fan, or a new fan. In such embodiments, a weighted average may be used to determine one or more centroids for a page. In some embodiments, these weights can be learned from a process which correlates the category's aggregate location with the effect of the fan location in the social networking system. In one example, such correlation can be determined by correlating the respective distances of users belonging to a category from the centroid with respect to the conversion rate. It should be appreciated that there can be many variations or other possibilities.

FIG. 3 illustrates an example of a page recommendation module 302 configured to provide page recommendations, according to an embodiment of the present disclosure. In some embodiments, the page recommendation module 106 of FIG. 1 can be implemented as the page recommendation module 302. As shown in FIG. 3, the page recommendation module 302 can include a candidate generation module 304, a candidate posting list filtering module 306, a location-based filtering module 308, and a campaign targeting module 310.

The candidate generation module 304 can be configured to determine a measure of similarity between the areas of influence that correspond to various pages. For example, for a first page, the candidate generation module 304 can determine a Jaccard similarity coefficient of the first page's area of influence and the respective area of influence for each page in a set of candidate pages. The candidate pages can be ordered, or ranked, with respect to their Jaccard similarity coefficients to the first page. In some embodiments, pages in the set of candidate pages that have a threshold similarity to the first page can be provided as suggestions to fans of the first page. Such suggestions can encourage fans of the first page to like, or fan, different pages that may be of interest to the fans. Consequently, fans of the first page are able to discover new content that may be of interest from the fanned candidate pages. Fanned candidate pages can also benefit by obtaining new fans. The Jaccard similarity coefficient is just one example measure of similarity and, naturally, any generally known approach for measuring pairwise similarity may be used depending on the implementation.

In general, a page's area of influence (e.g., p25 radius, p50 radius, p75 radius, etc.) can provide a measure of the spread of the page's influence among users in different geographic locations. Based on the page's measure of influence, the page can be categorized as a local, regional, or country page. For example, a local page can have a local area of influence (e.g., a city or a group of neighboring cities). In another example, a regional page can have a regional area of influence (e.g., a state or a group of neighboring states). In another example, a country page can have a country-wide area of influence (e.g., including a country or a group of neighboring countries). In some embodiments, the candidate posting list filtering module 306 can be configured to identify, for a first page, a set of candidate pages that have (i) the same, or similar, area of influence as the first page (e.g., any overlap between the p50 radii of the first page and a candidate page) and (ii) the same, or similar, geographic category (e.g., local, regional, country, universal, etc.), and to provide these as recommendations to fans of the first page.

Another example approach for providing page recommendations can based on evaluating other types of similarities in addition to area of influence similarity. For example, in some embodiments, seed-candidate relationships between entities can be utilized for purposes of providing page recommendations. For example, a seed may be any entity (e.g., social connection or friend, page, etc.) to which a connection is able to be formed in a social graph. A seed can be associated with candidates that have been determined to be similar to that seed. The seed may be associated with a corresponding posting list. This posting list can reference candidates for the seed that are categorized based on the type of similarity (e.g., topic similarity, fan similarity, location similarity, group similarity, visit similarity, administrator similarity, etc.) to the seed. In various embodiments, the candidate posting list filtering module 306 can measure a similarity between entities based, in part, on the various different types of similarities. Such similarities may include, for example, topic similarity, fan similarity, location similarity, group similarity, visit similarity, administrator similarity, to name some examples. In some embodiments, the candidate posting list filtering module 306 can filter similar entities based on an amount of overlap between the respective areas of influence for the entities. Thus, for example, the candidate posting list filtering module 306 can identify, for purposes of recommending, candidate entities (e.g., pages, groups, topics, etc.) that are similar to a first page in various dimensions provided that those pages satisfy a threshold amount of overlap between their respective areas of influence and the area of influence for the first page.

The location-based filtering module 308 can be configured to filter pages in a set of pages that are eligible for recommendation to a user based on the user's geographic location. For example, the location-based filtering module 308 can determine, based on the user's geographic location, whether the user is geographically located in an area of influence of a page. In one example, a determination can be made that the user is geographically located within a p25 radius, p50 radius, p75 radius, and/or a p100 radius that extends from a centroid associated with the page. If the geographic location of the user is a threshold distance from a centroid associated with the page, then the page can be filtered and, as a result, not be recommended to the user. In one example, if the geographic location of the user is more than twice the p100 distance from the centroid associated with the page, then the page may be filtered from the set of pages that are eligible for recommendation to the user and, consequently, not be recommended to the user.

The campaign targeting module 310 can be configured to utilize the respective centroids and/or areas of influence associated with pages to improve page campaign targeting. For example, a page's area of influence radii (e.g., p25, p50, p75, p100) can be used as features to predict which type of geographic region (e.g., neighborhood, city, state, country, etc.) is appropriate for the page to grow its audience, or fans, effectively. In some embodiments, the campaign targeting module 310 can provide a graphical user interface through which an administrator of the page can select and/or adjust the geographic region to be targeted for their campaign.

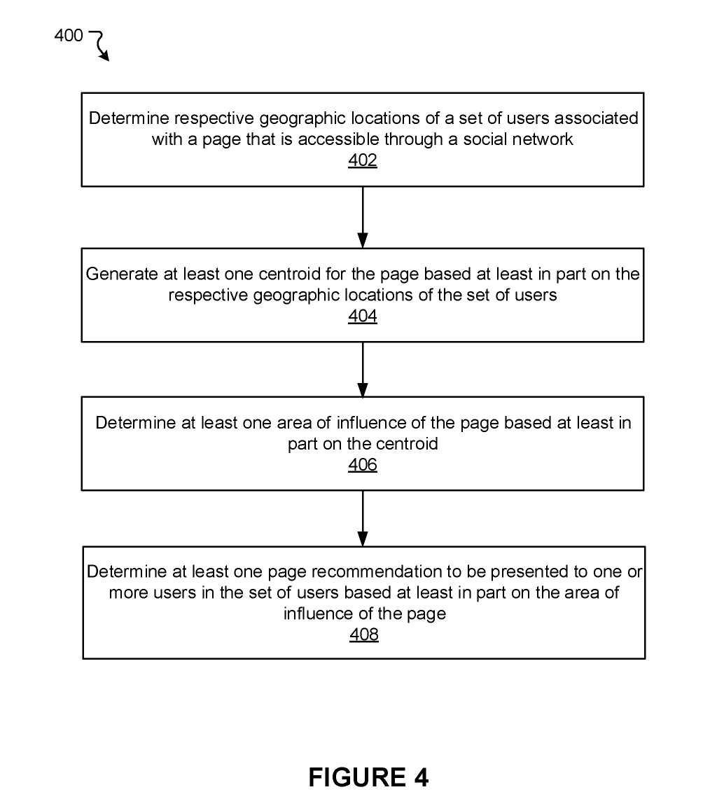

FIG. 4 illustrates an example process for determining page recommendations, according to an embodiment of the present disclosure. It should be appreciated that there can be additional, fewer, or alternative steps performed in similar or alternative orders, or in parallel, within the scope of the various embodiments discussed herein unless otherwise stated. At block 402, a determination is made of respective geographic locations of a set of users associated with a page that is accessible through a social network. At block 404, at least one centroid for the page is generated based at least in part on the respective geographic locations of the set of users. At block 406, at least one area of influence of the page is determined based at least in part on the centroid. At block 408, at least one page recommendation is presented to one or more users in the set of users based at least in part on the area of influence of the page.

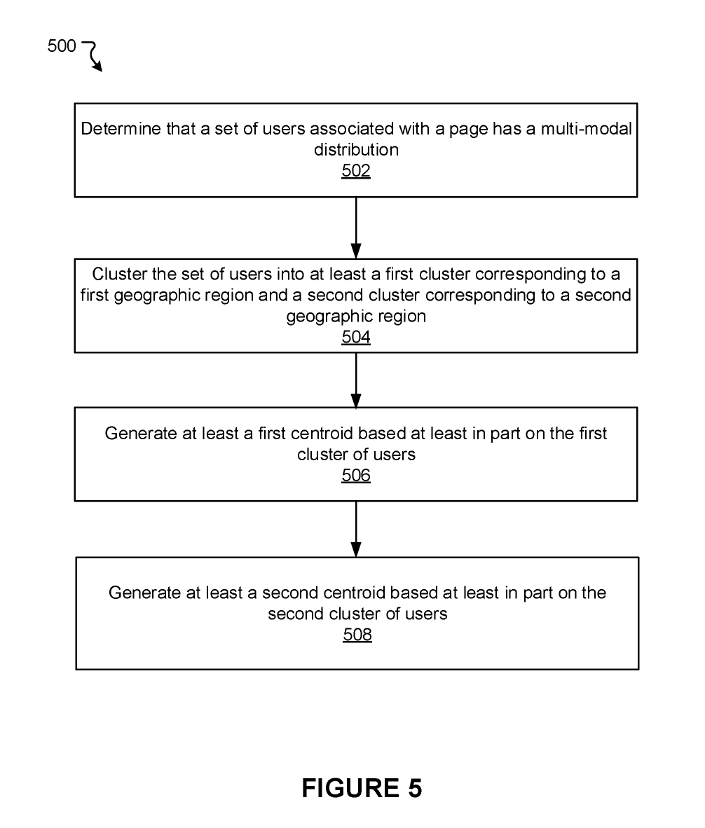

FIG. 5 illustrates an example process for generating multiple centroids for a page, according to various embodiments of the present disclosure. It should be appreciated that there can be additional, fewer, or alternative steps performed in similar or alternative orders, or in parallel, within the scope of the various embodiments discussed herein unless otherwise stated. At block 502, a determination is that a set of users associated with a page has a multi-modal distribution. At block 504, the set of users is clustered into at least a first cluster corresponding to a first geographic region and a second cluster corresponding to a second geographic region. At block 506, at least a first centroid is generated based at least in part on the first cluster of users. At block 508, at least a second centroid is generated based at least in part on the second cluster of users.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a page module 646. The page module 646 can, for example, be implemented as the recommendation module 102 of FIG. 1. As discussed previously, it should be appreciated that there can be many variations or other possibilities.

### Hardware Implementation

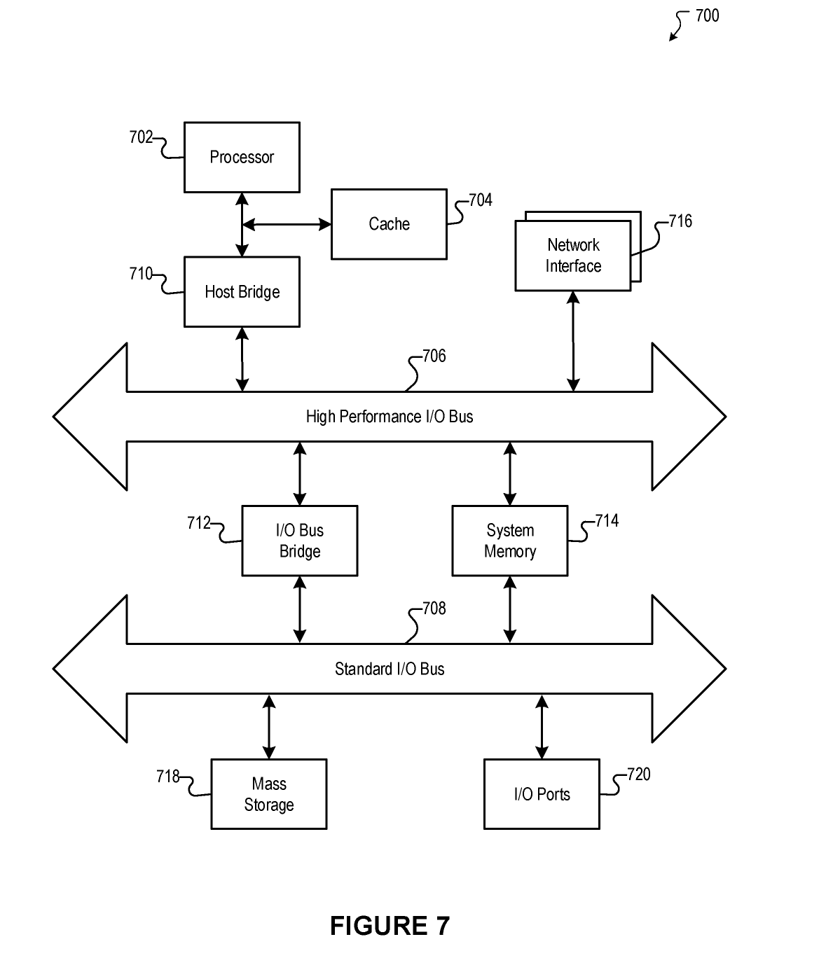

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, respective geographic locations of a set of users associated with a page that is accessible through a social network;
generating, by the computing system, at least one centroid for the page based at least in part on the respective geographic locations of the set of users;
determining, by the computing system, at least one area of influence of the page based at least in part on the centroid; and
determining, by the computing system, at least one page recommendation to be presented to one or more users in the set of users based at least in part on the area of influence of the page.

2. The computer-implemented method of claim 1, wherein determining the respective geographic locations corresponding to the set of users further comprises:
determining, by the computing system, the geographic location of a user based on an address referenced in a social network profile of the user;
determining, by the computing system, the geographic location of the user based on a centroid of geographic locations that correspond to check-ins performed by the user through the social network; or
determining, by the computing system, the geographic location of the user based on a centroid of geographic locations that correspond to social connections of the user in the social network.

3. The computer-implemented method of claim 1, wherein the respective geographic locations of the set of users are each represented as latitude-longitude coordinates, and wherein generating at least one centroid for the page further comprises:
determining, by the computing system, a mean of the respective latitude-longitude coordinates corresponding to each user in the set of users; and
determining, by the computing system, the centroid for the page based on the mean.

4. The computer-implemented method of claim 1, wherein generating at least one centroid for the page further comprises:
determining, by the computing system, that a number of the users associated with the page satisfy a large page threshold;
determining, by the computing system, a sample of the set of users;
determining, by the computing system, a mean of the respective latitude-longitude coordinates corresponding to each user in the sample; and
determining, by the computing system, the centroid for the page based on the mean.

5. The computer-implemented method of claim 1, wherein generating at least one centroid for the page further comprises:
determining, by the computing system, that a number of the users associated with the page satisfy a small page threshold;
generating, by the computing system, a preliminary centroid for the page using a first sample of the set of users;
determining, by the computing system, a second sample of users by discarding at least one user from the first sample having a geographic distance from the preliminary centroid that satisfies a threshold number of standard deviations; and
generating, by the computing system, the centroid for the page using the second sample of the set of users.

6. The computer-implemented method of claim 1, wherein determining at least one centroid for the page further comprises:
determining, by the computing system, that the set of users associated with the page has a multi-modal distribution;
clustering, by the computing system, the set of users into at least a first cluster corresponding to a first geographic region and a second cluster corresponding to a second geographic region;
generating, by the computing system, at least a first centroid based at least in part on the first cluster of users; and
generating, by the computing system, at least a second centroid based at least in part on the second cluster of users.

7. The computer-implemented method of claim 1, wherein determining at least one area of influence of the page based at least in part on the centroid further comprises:
determining, by the computing system, one or more areas of influence in which a respective threshold percentage of users associated with the page are geographically located.

8. The computer-implemented method of claim 1, wherein determining at least one page recommendation further comprises:
determining, by the computing system, a threshold similarity between an area of influence of at least one candidate page and the area of influence of the page.

9. The computer-implemented method of claim 1, wherein determining at least one page recommendation further comprises:
determining, by the computing system, a threshold similarity between an area of influence of at least one candidate page and the area of influence of the page; and
determining, by the computing system, that a geographic reach category for the candidate page matches a geographic reach category for the page.

10. The computer-implemented method of claim 9, wherein the geographic reach category categorizes a page as having a local, regional, or country-wide area of influence.

11. A system comprising:
at least one processor; and
a memory storing instructions that, when executed by the at least one processor, cause the system to perform:
determining respective geographic locations of a set of users associated with a page that is accessible through a social network;
generating at least one centroid for the page based at least in part on the respective geographic locations of the set of users;
determining at least one area of influence of the page based at least in part on the centroid; and
determining at least one page recommendation to be presented to one or more users in the set of users based at least in part on the area of influence of the page.

12. The system of claim 11, wherein determining the respective geographic locations corresponding to the set of users further causes the system to perform:
determining the geographic location of a user based on an address referenced in a social network profile of the user;
determining the geographic location of the user based on a centroid of geographic locations that correspond to check-ins performed by the user through the social network; or
determining the geographic location of the user based on a centroid of geographic locations that correspond to social connections of the user in the social network.

13. The system of claim 11, wherein the respective geographic locations of the set of users are each represented as latitude-longitude coordinates, and wherein generating at least one centroid for the page further causes the system to perform:
determining a mean of the respective latitude-longitude coordinates corresponding to each user in the set of users; and
determining the centroid for the page based on the mean.

14. The system of claim 11, wherein generating at least one centroid for the page further causes the system to perform:
determining that a number of the users associated with the page satisfy a large page threshold;
determining a sample of the set of users;
determining a mean of the respective latitude-longitude coordinates corresponding to each user in the sample; and
determining the centroid for the page based on the mean.

15. The system of claim 11, wherein generating at least one centroid for the page further causes the system to perform:
determining that a number of the users associated with the page satisfy a small page threshold;
generating a preliminary centroid for the page using a first sample of the set of users;
determining a second sample of users by discarding at least one user from the first sample having a geographic distance from the preliminary centroid that satisfies a threshold number of standard deviations; and
generating the centroid for the page using the second sample of the set of users.

16. A non-transitory computer-readable storage medium including instructions that, when executed by at least one processor of a computing system, cause the computing system to perform a method comprising:
determining respective geographic locations of a set of users associated with a page that is accessible through a social network;
generating at least one centroid for the page based at least in part on the respective geographic locations of the set of users;
determining at least one area of influence of the page based at least in part on the centroid; and
determining at least one page recommendation to be presented to one or more users in the set of users based at least in part on the area of influence of the page.

17. The non-transitory computer-readable storage medium of claim 16, wherein determining the respective geographic locations corresponding to the set of users further causes the computing system to perform:
determining the geographic location of a user based on an address referenced in a social network profile of the user;
determining the geographic location of the user based on a centroid of geographic locations that correspond to check-ins performed by the user through the social network; or
determining the geographic location of the user based on a centroid of geographic locations that correspond to social connections of the user in the social network.

18. The non-transitory computer-readable storage medium of claim 16, wherein the respective geographic locations of the set of users are each represented as latitude-longitude coordinates, and wherein generating at least one centroid for the page further causes the computing system to perform:
determining a mean of the respective latitude-longitude coordinates corresponding to each user in the set of users; and
determining the centroid for the page based on the mean.

19. The non-transitory computer-readable storage medium of claim 16, wherein generating at least one centroid for the page further causes the computing system to perform:
determining that a number of the users associated with the page satisfy a large page threshold;
determining a sample of the set of users;
determining a mean of the respective latitude-longitude coordinates corresponding to each user in the sample; and
determining the centroid for the page based on the mean.

20. The non-transitory computer-readable storage medium of claim 16, wherein generating at least one centroid for the page further causes the computing system to perform:
determining that a number of the users associated with the page satisfy a small page threshold;
generating a preliminary centroid for the page using a first sample of the set of users;
determining a second sample of users by discarding at least one user from the first sample having a geographic distance from the preliminary centroid that satisfies a threshold number of standard deviations; and
generating the centroid for the page using the second sample of the set of users.
